(19) United States
(12) Patent Application Publication
(10) Pub. No.: US 2024/0362562 A1
(43) Pub. Date: Oct. 31, 2024

(54) METHOD AND APPARATUS FOR PERFORMING ASSET LIFECYCLE MODELING

(71) Applicant: Copperleaf Technologies Inc., Vancouver (CA)

(72) Inventors: Balázs János KERESZTES, Guadalajara (ES); Stanley Thomas COLEMAN, North Vancouver (CA)

(21) Appl. No.: 18/141,072

(22) Filed: Apr. 28, 2023

(51) Int. Cl. G06Q 10/0635; G06N 5/04

(52) U.S. Cl. CPC G06Q 10/0635; G06N 5/04

(57) ABSTRACT

A method, apparatus and system for performing asset lifecycle modelling. The model is used to test various asset intervention hypotheses to generate a hazard rate and an intervention rate that may be used to minimize hazard risk across a system comprising assets that fail over their lifetimes.

### FIELD

The present disclosure relates, generally, to asset lifecycle modeling and more particularly, to asset lifecycle modeling using multiple failure hazard rates for proactive and reactive interventions.

### BACKGROUND

Asset-intensive industries, such as electrical utilities, rail networks, and water distribution companies, may experience challenges in determining asset lifecycles. For example, some organizations, e.g., a power company, can have in excess of thirty thousand assets (e.g., circuits, relays, transformers, etc.) on a plurality of circuits of an electrical transmission network that need to be maintained and sometimes repaired, upgraded, replaced, or refurbished. It is extremely difficult to determine when assets will fail and/or require replacing.

At any given time, assets have a certain probability of failing (to different extents), usually described by a curve where a specific percentage of failure is attributed to an age/condition. Normally an older asset has a higher probability of failure than a younger one. During its lifetime assets need interventions that would make sure they continue to operate. The operator of the asset must plan ahead and schedule interventions, based on the recommendations of the asset's manufacturer or based on historical data and perform the interventions regularly, to prevent failures. These are considered proactive interventions. If for some reason the asset produces a failure, stops functioning partly, or even entirely, the operator is usually required to perform an intervention outside of the schedule, on an ad-hoc basis. These are called reactive interventions and are normally much more expensive than proactive ones.

Both in a proactive or reactive manner, interventions are performed with different invasiveness, e.g., a maintenance is usually the cheapest, least invasive intervention, while a replacement is the most expensive and most invasive intervention.

Replacements can be like-for-like and non-like-for-like where the difference is whether the asset installed as a replacement is an exact copy of the one that we replaced or not. Currently, the most common modelling task is to try determining the monetized risk attributed to a failure that results in reactive interventions and the intervention schedule that mitigates most of this risk while adhering to existing financial or other kind of constraints.

There are many different methods that are used to estimate such a plan, but these solutions can't efficiently consider the alternatives because they either: (1) only consider a single intervention in the future, not a schedule, (2) cannot consider the asset's current condition, (3) assume survival (in other words: lack of failure with certainty) before or after the interventions, (4) cannot model realistically how a planned schedule of interventions would be adjusted in case of an unplanned failure, or (5) cannot analyze the problem space because of computational limitations.

Therefore, there is a need for a method and apparatus for performing computationally efficient asset lifecycle modeling that may be used to generate a realistic intervention plan.

### SUMMARY

The present disclosure relates, generally, to a method, apparatus and system used for performing asset lifecycle modeling. The model is used to test various asset intervention hypotheses to identify an optimal asset intervention schedule to minimize hazard risk across a system comprising assets that occasionally fail.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 depicts a high-level block diagram of an exemplary asset scenario providing data input to an asset lifecycle analyzer in accordance with at least one embodiment of the present principles;

FIG. 2 depicts a graphical representation of a survival/failure tree in accordance with at least one embodiment of the present principles;

FIG. 3 depicts a simplified graphical representation of the survival/failure tree of FIG. 2 in accordance with at least one embodiment of the present principles;

FIG. 4 depicts the graphical representation of the survival/failure tree of FIG. 2 having planned, proactive interventions included in the tree in accordance with at least one embodiment of the present principles;

FIG. 5 depicts a simplified graphical representation of the survival/failure tree of FIG. 4 in accordance with at least one embodiment of the present principles;

FIG. 6 depicts a flow diagram of a method of operation of the Multiple Failure Hazard Rate (MFHR) analysis software in accordance with at least one embodiment of the present principles;

FIG. 7-12 depict exemplary survival/failure trees and their related cache structures at various steps in the method of FIG. 6;

FIG. 13 depicts an exemplary probability of failure graph; and

FIG. 14 depicts an exemplary asset lifecycle model output comprising a baseline hazard rate and an intervention rate.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The following detailed description describes techniques (e.g., methods, processes, apparatus, and systems) for performing asset lifecycle modeling. For a given intervention age of an asset and a given interval of intervention (i.e., an intervention hypothesis), the model generates a curve showing a non-zero possibility that an intervention will be needed in any given year. The model may be used to test various asset intervention hypotheses to identify an optimal asset intervention schedule to minimize hazard risk across a system comprising assets that occasionally fail.

While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles are described with reference to an asset lifecycle model that produces two output curves that represent “risk” (i.e., a hazard rate curve and an intervention rate curve). The hazard rate curve represents the actual risk of having to perform a reactive intervention, while the intervention rate curve represents the probability of performing proactive interventions to mitigate the failure risk. These curves may be used to determine an asset intervention schedule (e.g., repair, replacement, refurbishment, like-for-like replacement, like-for-unlike replacement, maintenance, etc.). Such intervention schedules may be used to determine cost estimates and scheduling estimates for projects, embodiments of the present principles can be implemented to determine other estimates of project attributes.

In some embodiments, an asset lifecycle analyzer operates to analyze asset lifecycle information regarding a group of assets and produce an asset lifecycle model. The assets may be infrastructure that supports the viability of a particular business enterprise. For example, in a power generation scenario, the assets may include the power station turbine and generator, the power distribution equipment, and the transmission system components. In addition, the assets may be sub-components of components. As such, the term “assets” includes systems, system components and sub-components (i.e., part of an asset). In such a scenario, there could be thousands of assets that have various lifecycles and must be intermittently repaired or replaced (i.e., an intervention) to enable the power system to function at optimal performance levels. Other scenarios may involve factories, shipping centers, forestry, mining or logging operations, communications systems, and so on. Embodiments of the invention find use in any scenario where assets are used, and those assets require repair or replacement to enable the assets to continue supporting the enterprise.

In some embodiments, the asset lifecycle analyzer is a computer device executing software to perform the lifecycle analysis using asset information supplied by an enterprise. The asset information comprises, but is not limited to, an asset identifier, asset age, asset condition, and the like. This asset information is typically expressed as a condition decay curve plus a condition-based probability of failure curve or a Weibull distribution. This asset failure information may be captured through empirical study of asset function using sensors to capture the failure information. Such information may be processed using machine learning algorithms to combine and analyze the data to produce the asset condition decay curve(s).

The analyzer executes Multiple Failure Hazard Rate (MFHR) analysis software to apply a statistical analysis using the asset information and an intervention hypothesis (i.e., including an intervention age and an intervention interval) to produce a baseline understanding of the failure scenario. The intervention age is the age of the asset when the intervention is to first occur, and the intervention interval is the interval at which the intervention occurs after the first intervention. For example, a system may be activated and have a component scheduled for replacement 3 years after activation, then have the component scheduled for replacement every 10 years after the first replacement. In some embodiments, the age and interval may be the same (symmetrical), e.g., replace during year 2 and every 2 years thereafter) or, in other embodiments, the age and interval may not be the same (asymmetrical), e.g., replace during year 3 and every 5 years thereafter. The analysis may apply a plurality of intervention hypotheses (e.g., iterate using many hypotheses) to the asset lifecycle model to determine an optimal intervention schedule to fulfill operational goals for the scenario.

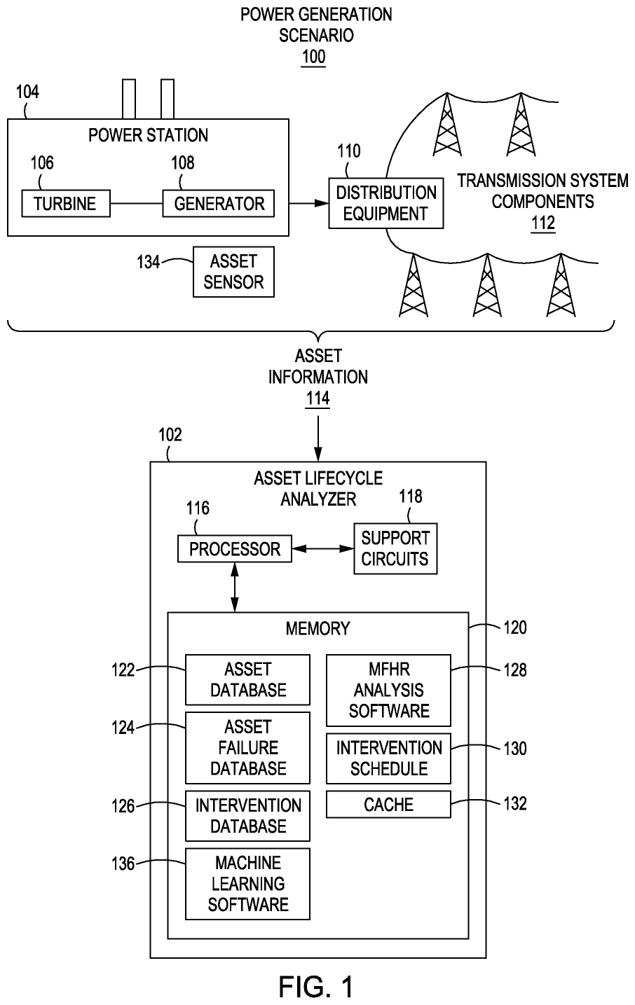

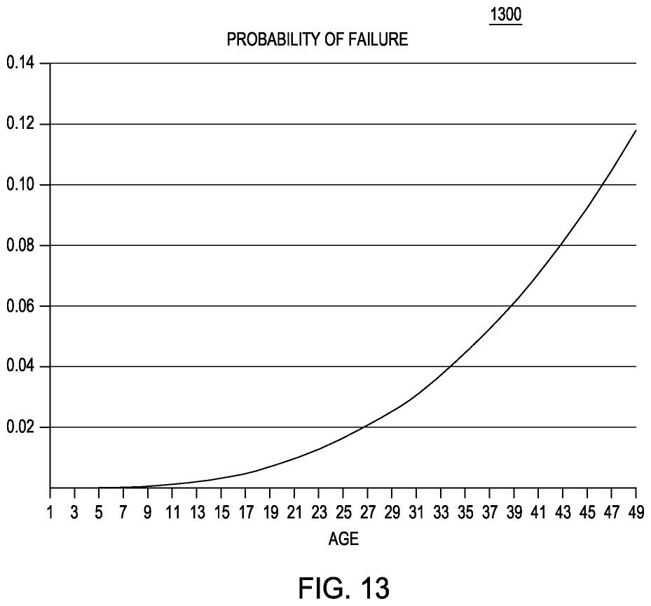

FIG. 1 depicts a high-level block diagram of an exemplary asset scenario 100 providing data input to an asset lifecycle analyzer 102 in accordance with at least one embodiment of the present principles. The scenario 100, for example, is a power generation scenario comprising various assets such as, but not limited to, a power station 104 with turbine 106 and generator 108, distribution equipment 110 and transmission system components 112. Other scenarios may involve, but are not limited to, factories, shipping centers, forestry, mining or logging operations, communications systems, and so on. Each asset is associated with various attributes contained in asset information 114. The information 114 may include, but is not limited to, an asset identifier along with various attributes such as age and condition of each asset. The age and condition may be represented by a probability of failure curve 1300 as shown in FIG. 13. Such a curve provides information about how an asset ages, i.e., the declination of condition of the asset over time. Such failure information may be gathered using asset sensors 134 to determine and classify asset failures. The data may be processed and analyzed using various processes including machine learning processes (i.e., executing machine learning software 136). The sensors and processes form a data source comprising asset information. The asset lifecycle analyzer 102 processes the information for each asset to generate an asset lifecycle model that produces a hazard rate curve and an intervention rate curve for the particular asset over its life expectancy.

The asset lifecycle analyzer 102 comprises at least one processor 116, support circuits 118 and memory 120. The at least one processor 116 may be any form of processor or combination of processors including, but not limited to, central processing units, microprocessors, microcontrollers, field programmable gate arrays, graphics processing units, and the like capable of executing software instructions to cause the controller to perform the functions described herein. The support circuits 118 may comprise well-known circuits and devices facilitating functionality of the processor(s). The support circuits 118 may comprise one or more of, or a combination of, power supplies, clock circuits, communications circuits, cache, displays, and/or the like.

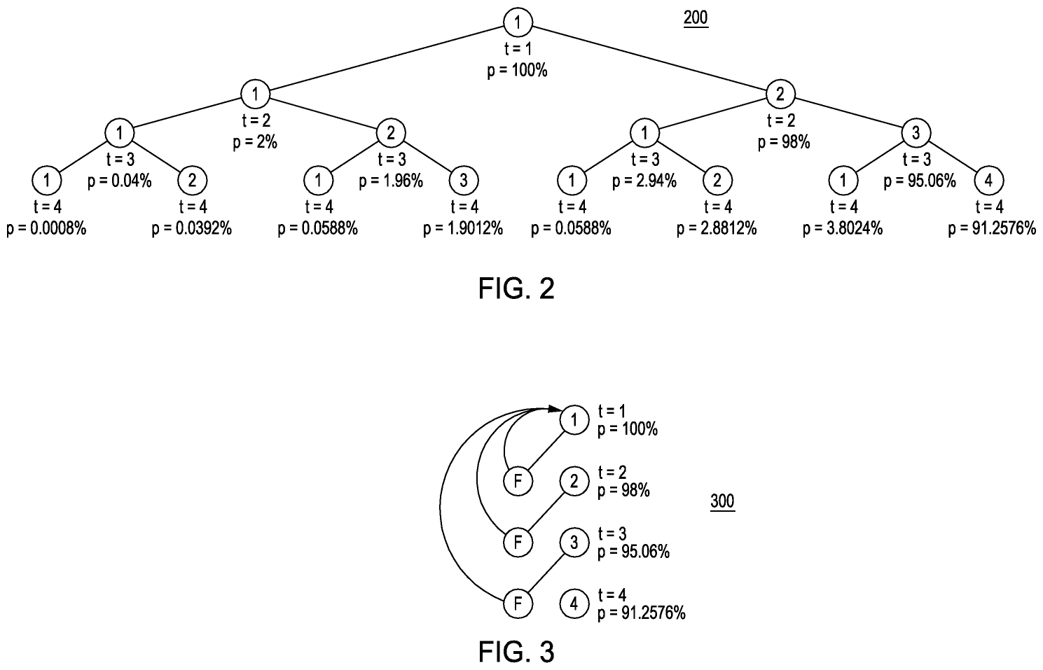

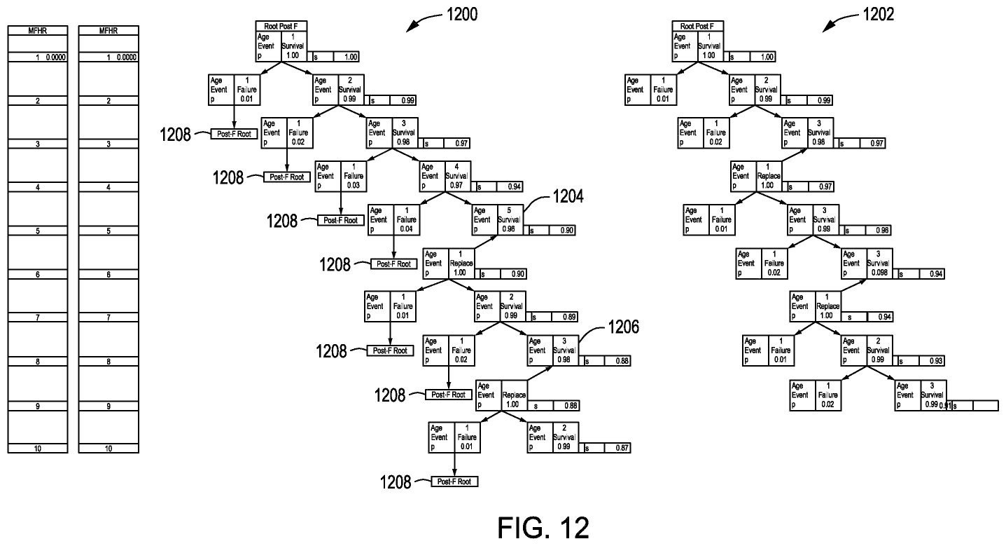

The memory 120 comprises one or more forms of non-transitory computer readable media including one or more of, or any combination of, read-only memory or random-access memory. The memory 120 stores software and data including, for example, Multiple Failure Hazard Rate (MFHR) analysis software 128 as well as various forms of data or information such as, but not limited to, an asset database 122, an asset lifecycle model 136, an asset failure database 124 (including asset condition curves 134), an intervention database 126 (including intervention hypotheses 138), an intervention schedule 130, a model output 140 (including a hazard rate 142 and an intervention rate 144) and a data cache 132. The hazard rate curve represents the probability of failure in any given time period over an asset's lifetime with interventions reactively occurring upon asset failure (i.e., a baseline curve). The intervention rate curve represents the probability of performing a proactive intervention to mitigate the failure risk. The various databases may be individual databases or may be combined into one or more databases. The MFHR analysis software 128 may comprise software instructions that, when executed by the processor 116, cause the asset lifecycle analyzer 102 to process the asset information 114 that is stored in the asset database 122, asset failure database 124 and intervention database 126. The analysis software 128 applies failure probabilities from the asset failure database 124 and intervention hypotheses 138 from the intervention database 126 to the asset lifecycle model 136 to determine a hazard rate 142 and an intervention rate 144 for a given asset and a given intervention hypothesis. The process may be repeated for a plurality of hypotheses to determine an optimal hypothesis (e.g., a hypothesis providing the lowest risk) as an optimal intervention schedule 130. The process can be repeated for each asset in the asset database 122 or a subset of assets in the database 124. Details of the operation of the MFHR analysis software 128 are described with respect to FIGS. 2-12 below.

FIG. 2 depicts a graphical representation of a survival/failure tree 200 in accordance with at least one embodiment of the present principles. The MFHR analysis software (128 in FIG. 1) uses a so-called survival/failure tree 200 that is a data object representation of a branching projection of events that can happen with an asset to cause a failure. The failure/survival tree 200 shows, for example, the probability space for an asset that has 2% chance of failure when it's 0-1 years old (node 1), 3% between ages 1-2 (node 2), 4% between ages 2-3 (node 3) and so forth. Each node represents a state of the asset where the number inside the node is its current age (1 being brand new). On right-hand branches the asset advances to the next timestep without failure, while on left-hand branches it assigns a failure and a consequent reactive replacement. The p values of the nodes show the cumulative probability of that specific path occurring. The hazard rate at any given timestep is a sum of all cumulative p values that are assigned to failure nodes.

Such a projection normally is calculated for a minimum of 50 years and, more commonly, for 100 or 150 years. However, the number of nodes (and paths) that must be considered becomes unmanageable above 25 years:
Nodes at 2 years: 7
Nodes at 5 years: 63
Nodes at 10 years: 2,047
Nodes at 25 years: 67,108,863
Nodes at 50 years: 2.25×10¹⁵
Nodes at 150 years: 2.85×10⁴⁵.

The MFHR analysis software implements two components that are designed to keep the calculation scalable and efficient: recursing and caching. The software does not need to create the entire tree with all the nodes—it only needs the unique paths: a continuous survival (right-hand path) and a failure node (F) at all survival nodes. These failure nodes although would only function as relay nodes that link back to a previous state of survival (a failure is followed by a reactive replacement such that the software can link the failure relay node back to the very first node of the tree).

FIG. 3 depicts a simplified graphical representation of the survival/failure tree 200 of FIG. 2 as a recursive tree 300 in accordance with at least one embodiment of the present principles. Having created the recursive tree 300, the software calculates the hazard rates for the asset by moving to the last direct path node (best-case, continuous survival) and move backwards. At any given timestep, the software computes a cumulative probability p of reaching that node, and the current age/condition of the asset. The software moves downward through the right-side nodes in the tree 300 and computes the cumulative probability at every timestep as follows:
1) Calculate the cache seed (current cumulative node p multiplied by the p of failure);
2) Calculate a set of rates of a sub-tree that is of the size (total number of years minus current t) on the original tree;
3) Cache these calculated rates to be reused by the next level;
4) Multiply the cached rates with the cache seed; and
5) Aggregate the seeded cache rates with the result rates.

With this method, the asset analysis software is making sure that all paths are calculated and that each level is calculated exactly once.

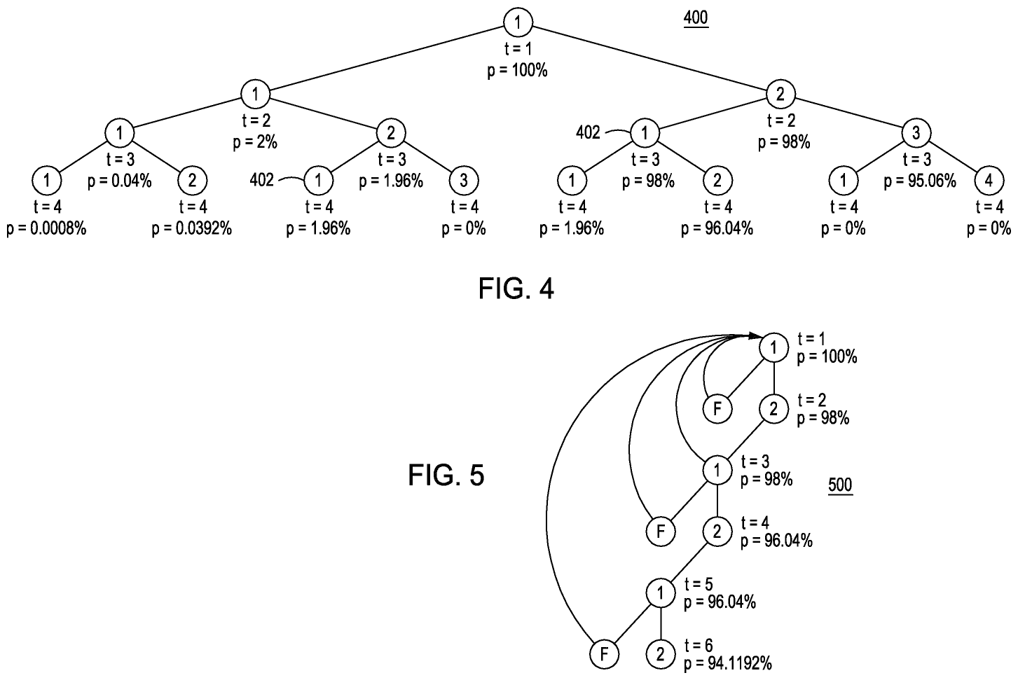

FIG. 4 depicts the graphical representation of the survival/failure tree of FIG. 2 having planned, proactive interventions included in the tree 400 in accordance with at least one embodiment of the present principles. Proactive intervention nodes 402 need to be generated as actual nodes instead of relay nodes that prune out survival nodes and replace failure nodes. (This is the case when it is assumed that once the age/condition that was required by the planned intervention is reached, the intervention happens with certainty.) The MFHR analysis software realistically models how an asset's intervention schedule would be adjusted in case there's a failure: a reactive intervention following an unplanned event would reset the planned schedule to its starting point and would only assign a proactive intervention if the asset reached the number of years that was specified in its intervention interval.

FIG. 5 depicts a simplified graphical representation of the survival/failure tree 400 of FIG. 4 to form tree 500 in accordance with at least one embodiment of the present principles. Because the schedule of planned interventions and the date of the first projected intervention can be asymmetric, the software must use two different trees. An asymmetrical schedule performs the first intervention at an age of the asset that is not the same as the intervention interval. For example, an intervention interval may be 10 years and have a first intervention at an asset age of 5 years such that the intervention schedule is 5 year, 15 year, 25 year, and so on. To utilize an asymmetric schedule, the first tree would be unlinked (no relay node would point to it) to accommodate the asymmetry, while the second tree would be symmetric, and all relay nodes would point to the second tree. As a result, proactive interventions are also represented as a curve, as at any given timestep there is a probability of performing an intervention instead of just at the specified years.

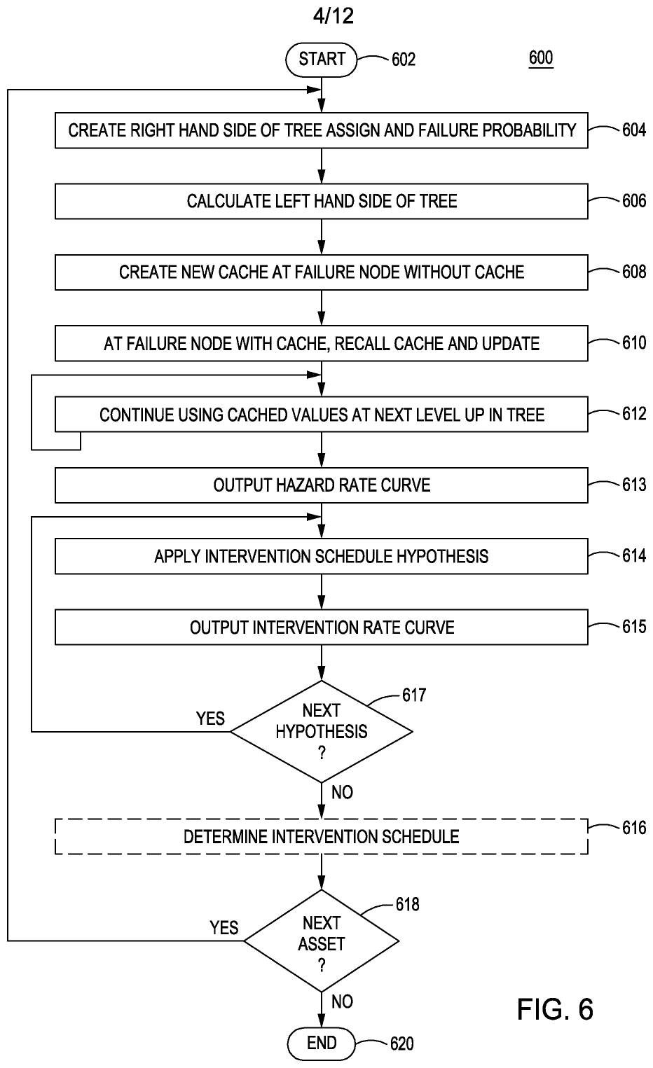

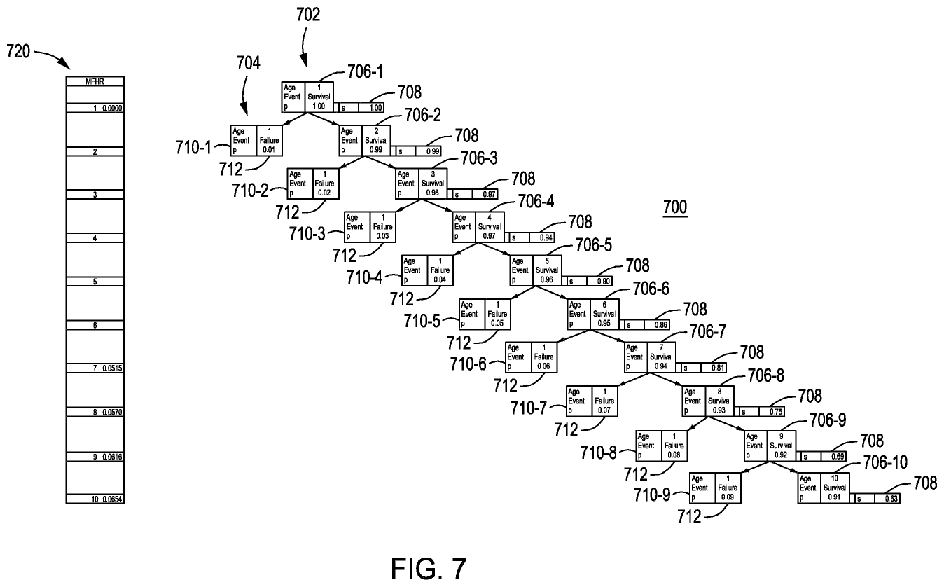

FIG. 6 depicts a flow diagram of a method 600 of operation of the MFHR analysis software in accordance with an embodiment of the present principles and FIGS. 7-12 depict exemplary survival/failure trees and their related cache structures at various steps in the method of FIG. 6. Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

The method 600 begins at 602 and proceeds to 604, where the method 600 creates the right-hand side 702 of the survival/failure tree (700 in FIG. 7) and associates a probability of failure 712 with each node (nodes 706-1, 706-2, 706-3 . . . , collectively nodes 706) in the tree 700 as well as computes a hazard rate (column 720). Using the continuous survival path, the method 600 calculates the cumulative probability (seed) 708 at each node 706 of reaching the last survival node (e.g., 706-10). The cumulative probability 708 is the probability of reaching a particular survival node 706. For example, the probability of surviving to year nine in the example of FIG. 7 is 0.69.

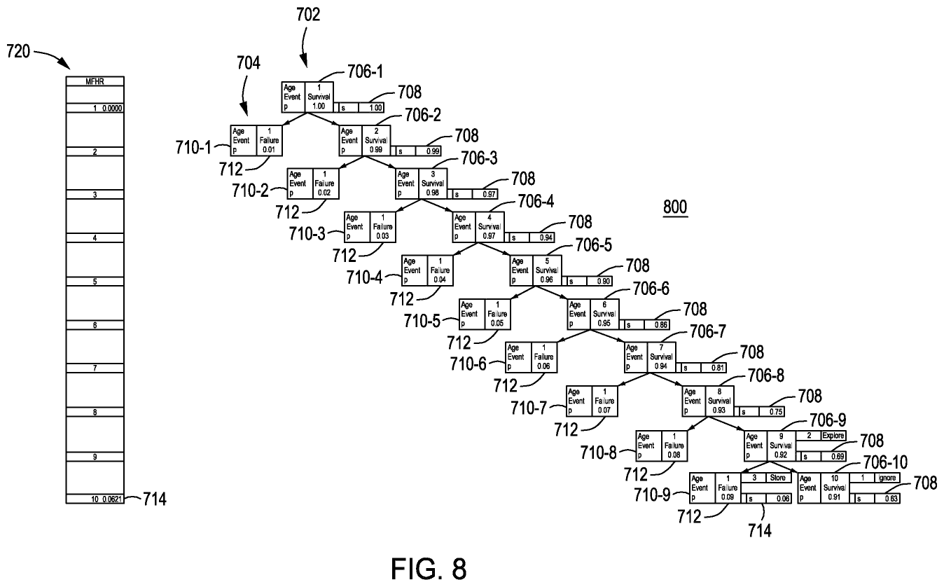

At 606, the method proceeds back up the tree on the same path and, at every node, the failure nodes (nodes 710-1, 710-2, 710-3, . . . , collectively failure nodes 710), are explored. Note, for this example, the probability of failing for a new asset in any given year is 0.01, while the probability of failure in subsequent years rises (e.g., 0.02 at age 2, 0.03 at age 3 and so on. The hazard rate (e.g., 0.06) is defined by the parent node's seed 708 (e.g., 0.69) times the failure node's probability 712 (e.g., 0.09) (i.e., the cumulative probability of surviving nine years and then failing is, for example, 0.09. The bottom right node 706-10 can be ignored because there's no failure node originating from it. One level up, at node 706-9, the method 600 needs to explore the node's failure path. Next level, at the failure node, the method 600 calculates the hazard rate 714 at that specific failure node 710-9 (previous seed times current p) and stores the hazard rate value 714. There are no further nodes to discover, thus the method 600 proceeds two levels up from the bottom level, i.e., to 706-8. A graphical representation of this process appears in FIG. 8.

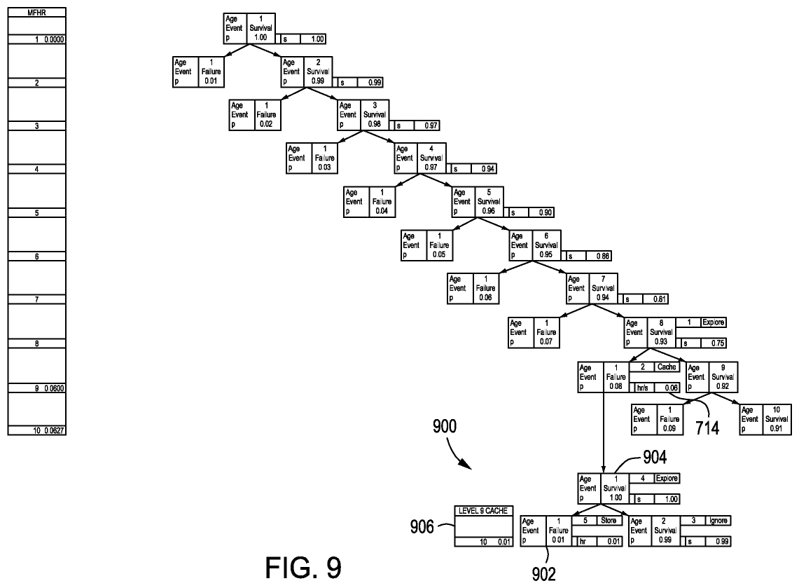

At 608, the method 600, when reaching a failure node that's not at the last level (node 706-10) (i.e., a failure node that can be followed by another failure within the calculation horizon), creates a new cache branch 900 for the number of levels left to reach the last one (e.g., level 9 cache will have 1 level+the root). This process models an asset failing and being replaced to form a new survival node 904, then the asset continues in use or may fail again in the following period. The cache branch 900 is a replica of the beginning of the tree where the root node is the failure node from which the cache was created. The cache value 906 need be only calculated once and then recalled for use in calculation of hazard rates for levels above the level of the cache branch 900. The method 600 calculates the hazard rate 902 on this truncated tree the same way as above to calculate the hazard rate 714. A graphical representation of this process appears in FIG. 9.

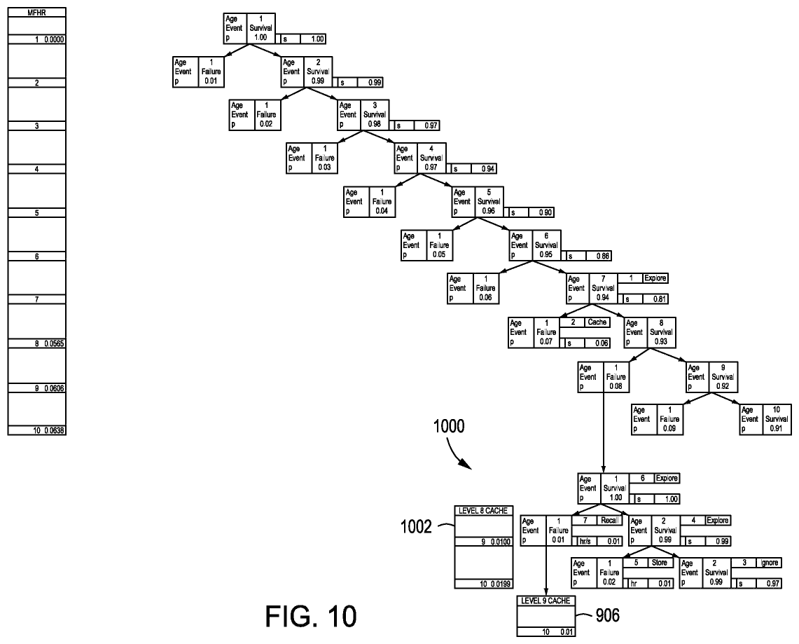

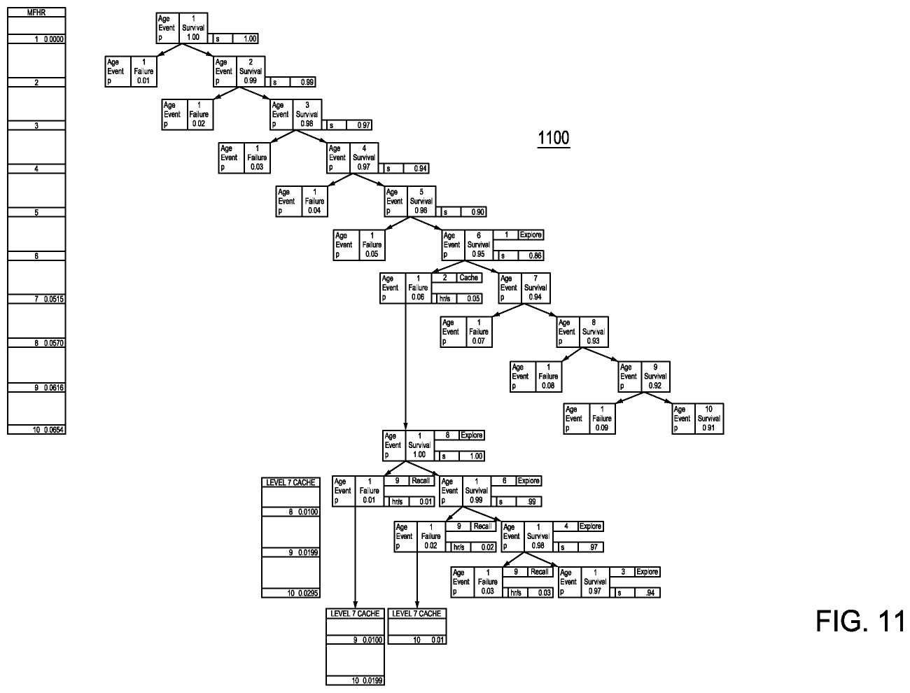

At 610, the method 600 follows the same logic as in 608, with the addition of recalling the cache 906 that was previously created. When generating a new cache branch 1000, reaching a failure node at a level that has a cache branch, the method 600 recalls that cache value, multiplies the cache contents with the current seed and adds the result to the hazard rates of the current cache. A graphical representation of this process appears in FIG. 10.

At 612, the method 600, at one more level up (node 706-6), continues using the cached values (e.g., 906, 1002, etc.) as the method 600 becomes closer to the root node 706-1. At each level, hazard rates are cached for use in the higher level computations. A graphical representation 1100 of this process appears in FIG. 11. This process continues, level-by-level, until the root node 706-1 is reached.

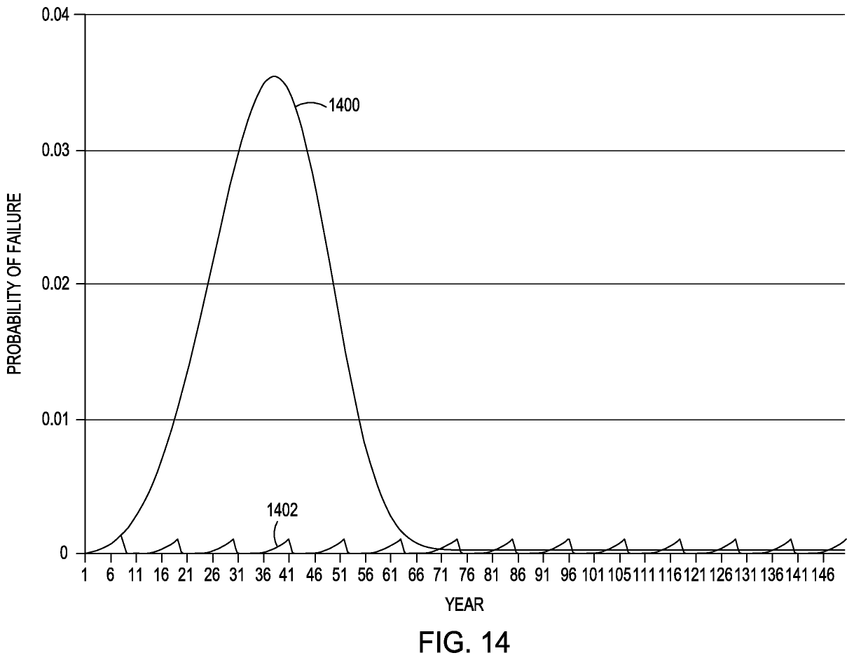

FIG. 14 depicts an output of method 600 at 613—a baseline hazard rate curve 1400 with probability of failure as the vertical axis and asset life as the horizontal axis.

At 614, the method 600 applies an intervention schedule hypothesis (i.e., time of first intervention and an intervention interval). The method 600 creates two trees, one (tree 1200) that represents the paths it could take before a failure and one (tree 1202) that describes the possibilities after a failure. In the example below, the method 600 uses the trees for an asset that has a program of replacing the asset in 4 years (when the asset reaches 5 years of age at node 1204) and then every third year (node 1206). Also, if the asset does not survive until the first scheduled intervention, the asset is replaced reactively, then the method 600 follows path 1208 and applies the post-failure every-third-year schedule (tree 1202). Apart from using a different tree after a failure node, and also calculating the intervention hazard rates, the method is similarly performed as without interventions (i.e., baseline, where the cumulative probability is multiplied by the probability of failure); however, when the intervention rate is computed and stored, the cumulative probability is multiplied by 100% (i.e., scheduled interventions have a 100% probability of occurring).

FIG. 14 depicts an output of method 600 at 615—an intervention rate curve 1402 with probability of failure as the vertical axis and asset life as the horizontal axis. This exemplary curve is for an intervention schedule starting in year 4 and having an intervention every 11 years. Note that the probability of failure in any year is substantially less than the baseline hazard rate curve 1400 (reactive intervention).

At 617, the method 600 queries whether another intervention hypothesis should be applied to the model. If the query is affirmatively answered, the method 600 returns to 614 to apply another hypothesis and produce another intervention rate curve. If the query is negatively answered, the method 600 proceeds to 616 where the intervention rate curves may optionally be analyzed to determine an intervention schedule.

A standard use case includes testing the same asset with different “first intervention age” (the first REPLACE in the left tree) and/or different “replacement intervals”, i.e., apply various intervention hypotheses. Finding the “optimal interval” means comparing symmetric program scenarios (the first intervention age and the interval are equal) and finding the one interval that has the lowest aggregate costs. At 616, the method 600 optionally outputs the optimal intervention schedule for the asset. At 618, the method 600 queries whether another asset is to be processed to generate hazard and intervention rate curves for the next asset. If the query is answered affirmatively, the method 600 returns to 604 to process the asset information of another asset. If the query is negatively answered, the method 600 proceeds to 620 and ends. By processing each asset in a scenario, embodiments of the invention produce a comprehensive asset lifecycle model and related asset intervention schedules for each asset in the scenario.

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AB, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

What is claimed:

1. A method for generating an asset lifecycle model, comprising:
a) receiving asset information comprising asset probability of failure over an expected life span of an asset;
b) creating a failure tree having a plurality of nodes, where each node represents a period of time within which an asset may fail;
c) assigning an asset probability of failure to each node in the failure tree;
d) computing a cumulative probability of failure at each node in the failure tree;
e) applying an intervention to at least one node in the failure tree; and
f) calculating a hazard rate and an intervention rate based upon the intervention and the cumulative probability of failure.

2. The method of claim 1 wherein the intervention is reactive or proactive.

3. The method of claim 2 wherein the intervention is reactive at each failure node and the hazard rate is a baseline hazard rate.

4. The method of claim 2 wherein the intervention is proactive and the intervention rate is a probability of performing proactive interventions to mitigate a failure risk.

5. The method of claim 1, further comprising:
applying a plurality of intervention hypotheses;
calculating a hazard rate and an intervention rate for each intervention hypothesis in the plurality of intervention hypotheses;
determining an optimal intervention hypothesis based upon the hazard rate and intervention rate calculated for each intervention hypothesis; and
defining an intervention schedule based upon the optimal intervention hypothesis.

6. The method of claim 5, wherein the intervention hypothesis comprises proactively replacing, maintaining, or repairing the asset.

7. The method of claim 6, wherein the intervention schedule comprises replacing, maintaining, or repairing the asset at scheduled intervals over the expected life of the asset.

8. The method of claim 1, further comprising:
repeating a)-f) for a plurality of assets.

9. A non-transitory machine-readable medium having stored thereon at least one program, the at least one program including instructions which, when executed by a processor, cause the processor to perform a method in a processor based system for asset lifecycle modelling, comprising:
a) receiving asset information comprising asset probability of failure over an expected life span of an asset;
b) creating a failure tree having a plurality of nodes, where each node represents a period of time within which an asset may fail;
c) assigning an asset probability of failure to each node in the failure tree;
d) computing a cumulative probability of failure at each node in the failure tree;
e) applying an intervention to at least one node in the failure tree; and
f) calculating a hazard rate and an intervention rate based upon the intervention and the cumulative probability of failure.

10. The method of claim 9 wherein the intervention is reactive or proactive.

11. The method of claim 10 wherein the intervention is reactive at each failure node and the hazard rate is a baseline hazard rate.

12. The method of claim 10 wherein the intervention is proactive and the intervention rate is a probability of performing proactive interventions to mitigate a failure risk.

13. The method of claim 9, further comprising:
applying a plurality of intervention hypotheses;
calculating a hazard rate and an intervention rate for each intervention hypothesis in the plurality of intervention hypotheses;
determining an optimal intervention hypothesis based upon the hazard rate and intervention rate calculated for each intervention hypothesis; and
defining an intervention schedule based upon the optimal intervention hypothesis.

14. The method of claim 13, wherein the intervention hypothesis comprises replacing, maintaining, or repairing the asset.

15. The method of claim 13, wherein the intervention schedule comprises replacing, maintaining, or repairing the asset at scheduled intervals over the expected life of the asset.

16. The method of claim 9, further comprising:
repeating a)-f) for a plurality of assets.

17. A system for performing asset lifecycle monitoring, comprising:
at least one data source comprising asset information;
a computing device comprising a processor and a memory having stored therein at least one program, the at least one program including instructions which, when executed by the processor, cause the computing device to perform a method, comprising:
a) receiving asset information comprising asset probability of failure over an expected life span of an asset;
b) creating a failure tree having a plurality of nodes, where each node represents a period of time within which an asset may fail;
c) assigning an asset probability of failure to each node in the failure tree;
d) computing a cumulative probability of failure at each node in the failure tree;
e) applying an intervention to at least one node in the failure tree; and
f) calculating a hazard rate and an intervention rate based upon the intervention and the cumulative probability of failure.

18. The system of claim 17, wherein the data source further comprises sensors for gathering asset information.

19. The system of claim 18, wherein the data source further comprises machine learning software, that when executed by a processor, processes the asset information.

20. The system of claim 17, wherein the method further comprises:
repeating a)-f) for a plurality of assets.
